(19) United States
(12) Patent Application Publication
(10) Pub. No.: US 2014/0040966 A1
(43) Pub. Date: Feb. 6, 2014

(54) Multi-Channel Multi-Stream Video Transmission System

(71) Applicant: Safeciety LLC, Hoffman Estates, IL (US)

(72) Inventors: Shidong Chen, Hoffman Estates, IL (US); Honghui Xu, Buffalo grove, IL (US)

(21) Appl. No.: 13/938,201

(22) Filed: Jul. 9, 2013

Related U.S. Application Data
(60) Provisional application No. 61/669,881, filed on Jul. 10, 2012.

(51) Int. Cl. H04N 21/61; H04N 21/643; H04N 21/2365

(52) U.S. Cl. CPC H04N 21/6118; H04N 21/2365; H04N 21/64322
USPC 725/111

(57) ABSTRACT

In one aspect the present invention provides a mechanism to carry analog video, digital video and other types of data over a single cable simultaneously between the camera modem and the monitor modem. The analog video has low latency and can be used as real time monitoring, while the digital video is usually compressed high definition video and carried in IP packets. In the camera modem, the analog video is digitized and decoded into digital video, which is further compressed by a near-zero latency video encoder. All types of data, including the compressed analog video and digital video, are multiplexed together to form a single digital stream and transmitted over the cable. In the monitor modem at the other end of the cable, the near-zero latency video stream originated from analog video is de-multiplexed from the single digital downstream, decompressed and finally the corresponding analog video is reconstructed.

This application refers to the prior provisional application under U.S. application Ser. No. 61/669,881 filed on Jul. 10, 2012.

### SUMMARY OF THE INVENTION

In one aspect the present invention provides a mechanism to carry analog video, digital video and other types of data over a single cable simultaneously between the camera side modem and the monitor side modem. The analog video has low latency and can be used as real time monitoring, while the digital video is usually compressed high definition video and carried in IP packets. In the camera modem, the analog video is digitized and decoded into digital video, which is further compressed by a near-zero latency video encoder. All types of data, including the compressed analog video and digital video, are multiplexed together to form a single digital stream and transmitted over the cable. In the monitor modem at the other end of the cable, the near-zero latency video stream originated from analog video is de-multiplexed from the single digital downstream, decompressed and finally the corresponding analog video is reconstructed by the analog encoder.

In another aspect the present invention uses one monitor modem with a single transceiver inside to exchange data with multiple camera modems through multiple cables by time-division multiple access (TDMA) or orthogonal frequency-division multiple access (OFDMA). In TDMA embodiment, different cameras are assigned with different time slots to carry their two-way communication traffic; in OFDMA embodiment, different cameras are assigned with different frequency bins or a combination of time slots and frequency bins to carry their two-way communication traffic. Link discovery, synchronization and negotiation are designed to support plug-n-play. That is, when a camera is connected, its link can be automatically established without disruption of other links; similarly; when a camera is disconnected, its link can be terminated without disruption of other established links.

In another aspect the present invention provides a repeater mode, a mechanism to extend the cable run without degrading analog video quality. The repeater mode also enables multiple cameras to share a single long-reach cable. In one embodiment of the present invention, a pair of monitor modem and camera modem can be connected back-to-back to form such a repeater.

### BRIEF DESCRIPTION OF THE DRAWINGS

FIG. 1 is an embodiment of the present invention.

FIG. 2 illustrates the camera modem.

FIG. 3 illustrates the analog video processor.

FIG. 4 illustrates the monitor modem.

FIG. 5 illustrates the analog video de-processor.

FIG. 6 illustrates the cascade connection of the monitor modems.

FIG. 7 illustrates an embodiment of IP engine.

FIG. 8 illustrates another embodiment of IP engine.

FIG. 9 illustrates the repeater structure.

FIG. 10 illustrates an embodiment of the repeater connections.

FIG. 11 illustrates another embodiment of the repeater connections.

FIG. 12 illustrates the slot assignment and probing slot.

### BACKGROUND OF THE INVENTION

1. Field of Invention

The present invention relates to security surveillance systems.

2. Background

In security surveillance systems, the analog cameras provide video in analog formats such as CVBS (color, video, blanking, and sync). The analog video has the advantage of near-zeros latency, which is critical for some surveillance environments, such as banks and casinos. However, the transmission distance is limited because the analog video quality degrades as cable length increases. On the other hand, high definition (HD) internet protocol (IP) cameras provide the convenience of remote monitoring because IP packets are used to transmit videos. Ethernet repeaters and switches can be used to extend Ethernet link without degrading the video quality and the video can be viewed over LAN or even the internet. At the same time, HD IP cameras can provide higher video quality than analog cameras. But IP cameras put some challenges on the security surveillance transmission systems. Firstly, IP packets are usually transmitted over Ethernet cables, which are not compatible with existing coaxial cables or twisted pair cables. Secondly, IP streaming video may require a return channel for acknowledgement packets, which does not exist in traditional surveillance systems. Thirdly, the HD videos usually have high latency, resulting from IP transmission delay and video compression and decompression. Thus it is not suitable for real time security surveillance.

The present invention provides a mechanism to transmit both the analog video and digital IP video simultaneously over the existing infrastructure, such as the coaxial cable or twisted pair cable. This enables the surveillance system to combine the advantages of near-zero latency of analog video and high quality of digital HD video. Furthermore, the present invention provides a mechanism to use repeaters to extend the cable without degrading the analog video quality.

In security surveillance systems, the monitor side usually needs to monitor many security cameras at the same time. It is convenient and cost effective to use only one modem to receive videos from multiple cameras. The present invention presents a mechanism to use a single monitor side modem to communicate with multiple camera modems.

### DETAILED DESCRIPTION OF THE INVENTION

FIG. 1 is an embodiment of the present invention, which contains n camera modems 101, 103, 105 and one monitor modem 109 which are connected by n cables 106, 107, 108 respectively. Video/data information can be exchanged between the cameras 100, 102, 104 and the monitor side unit 120. The monitor side unit 120 can be a DVR (digital video recorder), a personal computer, or other monitoring devices. The camera can provide multiple outputs, such as HD IP video, analog CVBS video and/or downstream audio. The monitor side unit can also provide multiple outputs, such as IP packets, RS 485, upstream audio, and/or PTZ (pan, tilt, zoom) control signal. The present invention uses a single monitor side modem to communicate with multiple cameras. The two-way traffic between each camera modem and the monitor modem may contain multiple streams, including, but not limited to, analog video, digital video, audio, RS485 and PTZ control.

In FIG. 1, n is a small integer number, such as 1, 2, 3 or 4. The number of camera modems connected to the monitor modem may change over time. The monitor modem is able to detect the existence of a camera modem automatically. When a camera modem is connected, the monitor modem can find it automatically and establish the two-way communication link without disruption of other established links. Similarly, a camera modem can be disconnected and its link can be terminated without disruption of other established links.

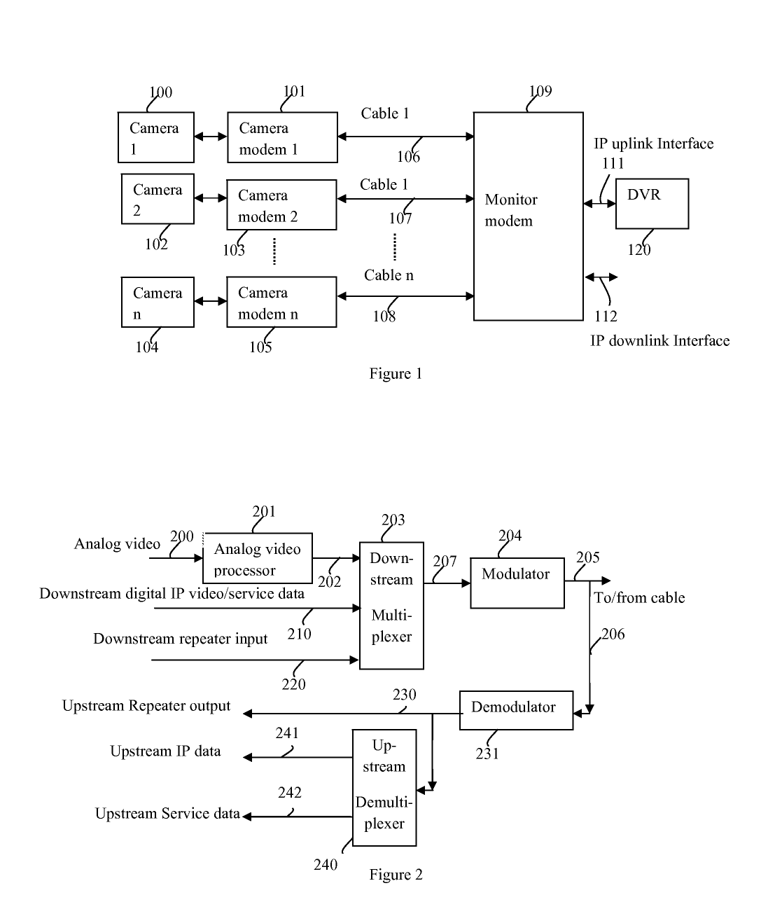

The details of the camera modem 101, 103 or 105 are shown in FIG. 2. The camera provides two signals to the camera modem. One is the analog video 200. The other is downstream digital IP video/data 210. The digital data can be audio, RS 485 or other types of data depending on camera implementations. Another input signal of the camera modem is the digital data/clock signal 220 used for repeater function. The repeater retransmits the received signal and thus extends the signal to a longer distance.

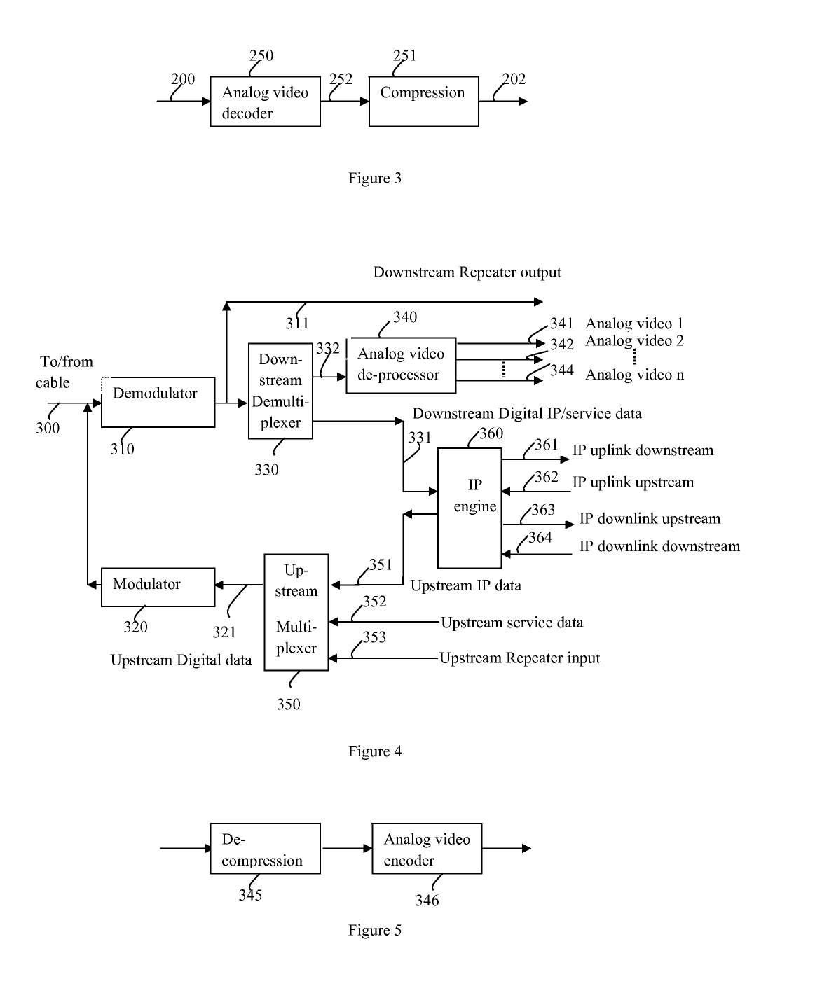

In FIG. 2, the analog video signal 200 is processed by an analog video processor 201 to convert analog video signal 200 into digital data stream 202. The analog video processor 201 is shown in FIG. 3, where the analog video signal 200 is firstly converted into digital signal by the analog video decoder 250 and then the resulting digital video signal 252 is processed by the compression block 251. The analog video decoder 250 digitalizes the analog video by means of deriving the corresponding digital video, or simply digitalizes the analog waveform. The compression block 251 reduces the data size while keeps the feature of near-zero latency of the analog video. In another embodiment of the present invention, the analog camera can provide signal 252 or signal 202 directly. The compression block 251 adopts near-zero latency compression methods such as DPCM (Differential pulse-code modulation), or Motion JPEG. The three input signals 202, 210, 220 are then multiplexed into one digital downstream 207 by the downstream multiplexer 203 and sent to the cable by the modulator 204. The multiplexer 203 needs to tag each input signal with a different identity number, or group it according to a pre-defined rule known to both the transmitter and the receiver such that the receiver is able to recover each individual signal. The modulator 204 converts the digital data 207 into a modulated signal suitable for transmission over the cable. Different modulation schemes can be used, such as QAM (Quadrature amplitude modulation) modulated single carrier signal or DMT (discrete multi-tone modulation). In the modulator, appropriate coding is also necessary to improve transmission reliability over frequency selective and noisy channel commonly seen over the cable.

At the same time, in FIG. 2, the camera modem receives upstream signal 206 from the cable and the demodulator block 231 decodes the received signal 206 and generates upstream digital data 230. On another embodiment of the present invention, the downstream and/or upstream digital data may not be in the format of IP packet and are called service data. The service data can also be exchanged between the cameras and the DVR. Signal 230 can be sent out directly as upstream repeater output, or it can be de-multiplexed into upstream IP data 241 and upstream service data 242.

The monitor modem 109 is shown in FIG. 4. The downstream signal 300 received from the cable is demodulated by the demodulator 310 and generates signal 311 which recovers the digital downstream data 207 transmitted by the corresponding camera modem. The output of the demodulator 311 can be sent out directly as the downstream repeater output, or it can be de-multiplexed into two types of streams of data by downstream demultiplexer 330. One type of stream 332 goes into the analog video de-processor 340 to recover the analog video. The reconstructed analog video 341 recovers the analog video from camera 100, 342 recovers the one from 102, and 344 recovers the one from 104. The other stream 331 is downstream digital IP video/service data. The analog video de-processor 340 is shown in FIG. 5, where a decompression block 345 is followed by an analog video encoder 346. The decompression block 345 recovers digital video signal 252 from the compressed digital video data. The analog video encoder 346 reconstructs the analog video signal 200, which can be directly viewed or recorded by the existing analog security surveillance equipments. The compression and decompression processes in FIG. 2 and FIG. 4 incur near-zero delay and thus reserve the real time feature of analog video link. In another embodiment of the present invention, digital video signal recovered by the decompression block can be sent out directly with a digital format, such as BT. 656 format. In the upstream direction, the upstream IP data 351, upstream service data 352, and/or upstream repeater input 353 are multiplexed into one signal digital stream 321 by the multiplexer 350. The upstream data 321 is modulated by the modulator 320 and sent to the cable.

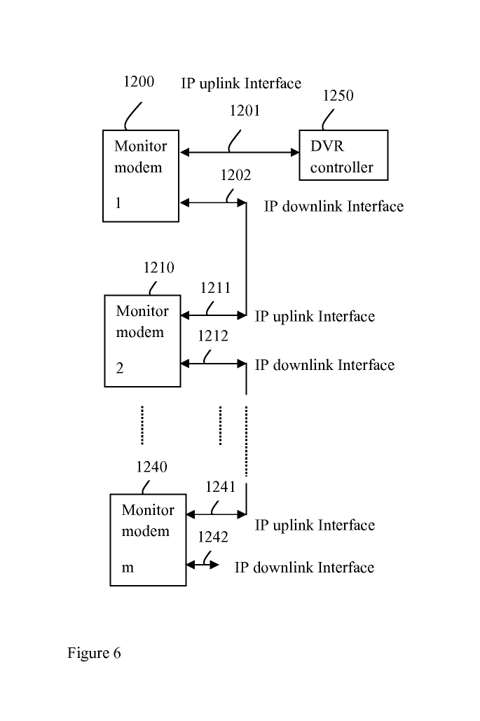

In the monitor modem as shown in FIG. 4, there are two interfaces called uplink interface and downlink interfaces respectively. At the uplink interface, the modem receives upstream data 362 from the DVR and sends downstream data 361 to the DVR. At the downlink interface, the modem receives downstream data 364 from another monitor modem and sends upstream data 363 to another monitor modem. These two interfaces are used for direct connection with a DVR or cascade connection with another monitor modem. In the cascade mode, two or more monitor modems are connected together by the uplink interface and downlink interface. A cascade connection is exemplified in FIG. 6, where m monitor modems 1200, 1210, . . . , 1240 are cascaded together and the first modem 1200 is connected to the DVR controller 1250 by the interface 1201. The cascade connection is useful for security surveillance application, where a single DVR controller 1250 can control multiple monitor modems and thus multiple cameras without LAN switch.

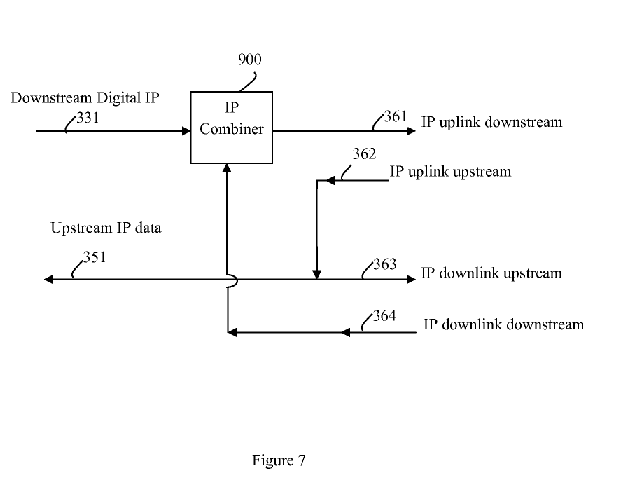

In FIG. 4, there is an IP engine 360, which connects the IP uplink interface signals 361 and 362, the IP downlink interface signals 363 and 364 and the internal IP interface signals 331 and 351. The IP engine 350 decides how to forward the packets from one interface to other interfaces depending on the forwarding policy. Conventionally the IP engine is a multiple port open systems interconnection (OSI) model layer 2 switch. One aspect of the invention significantly simplifies the switch design by removing the switching database and the associated MAC address learning, aging and lookup for forwarding. One embodiment of the IP engine is detailed in FIG. 7, where the IP combiner 900 is an apparatus that merges two input streams into one output stream by forwarding both input streams to the same output port with appropriate buffering and scheduling. In FIG. 7, the IP combiner 900 merges both downstream digit IP input 360 and IP downlink downstream 364 into IP uplink downstream 361, while IP uplink upstream 362 is simply duplicated to upstream IP data 351 and IP downlink upstream 363. As can be seen in FIG. 7, the upstream IP packets originated from DVR simply go to all cameras. In this embodiment, the IP engine does not need to recognize the MAC address or the IP address, and packet forwarding is implemented in layer 1. This embodiment supports IP traffic between a monitor side host and a camera while the inter-camera IP traffic is prohibited. This can be a desired security feature for some applications that require all installed IP cameras to be electronically isolated from each other.

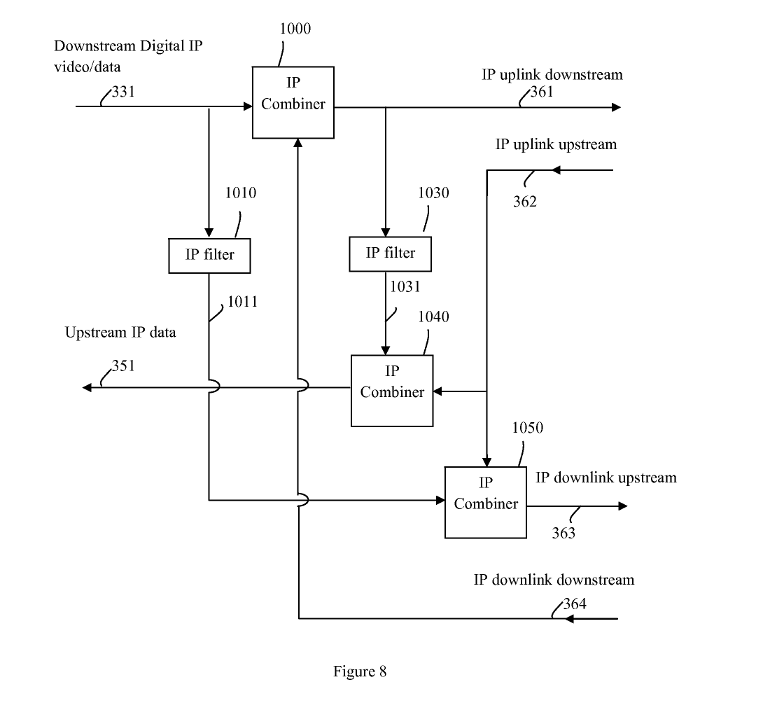

Another embodiment of such IP engine implemented in layer 2 is detailed in FIG. 8. Similar to the previous embodiment shown in FIG. 7, the downstream digital IP 360 and IP downlink downstream 364 are both forwarded by IP combiner 1000 to produce IP uplink downstream 361. However downstream 360 is filtered by IP filter 1010 and a filtered downstream digital IP 1011 is produced. A typical IP filter passes some incoming IP packets while discards all the others. Similarly, IP uplink downstream 361 is filtered by IP filter 1030 and the filtered IP uplink downstream 1031 is generated. Stream 1031 and IP uplink upstream 362 are merged by IP combiner 1040 to generate upstream IP data 351. The filtered downstream digital IP 1011 is also merged with IP uplink upstream 362 to form IP downlink upstream 363. One embodiment of the present invention uses an IP filter that only passes broadcast traffic and IP multicast traffic while discards all unicast traffic. The IP filtering is simply based on destination address type, not on an address itself. The destination address can be the destination MAC address or IP address of the packet. If the destination address is a broadcast address or a multicast address, the packet is passed through the IP filter, otherwise not passed. This allows the broadcast traffic and multicast traffic from one camera to reach other cameras connected to the same monitor modem, those connected to cascaded monitor modems as shown in FIG. 6 and further all others connected by IP networks. Without building a complicated and costly full-blown switch, the present invention allows limited communication between cameras. The inter-camera broadcast and multicast can be used to support inter-camera cooperation, where cameras can, for example, exchange instant information within a network or a group without knowing each other's IP address, and form an intelligent camera network that can watch, track and record a certain object of interest. Another embodiment of the said IP filter is an all-pass filter which simply passes all incoming traffic to the output. For the all-pass filter, its input is directly wired to its output. This supports all broadcast, multicast and unicast traffic among all cameras and DVR.

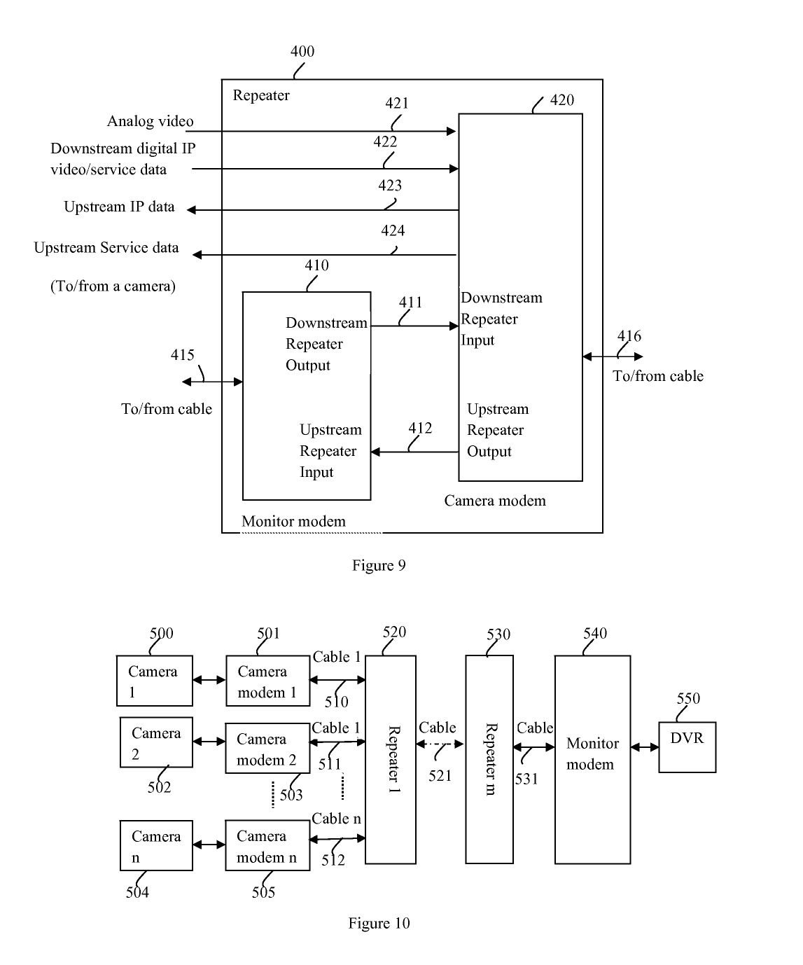

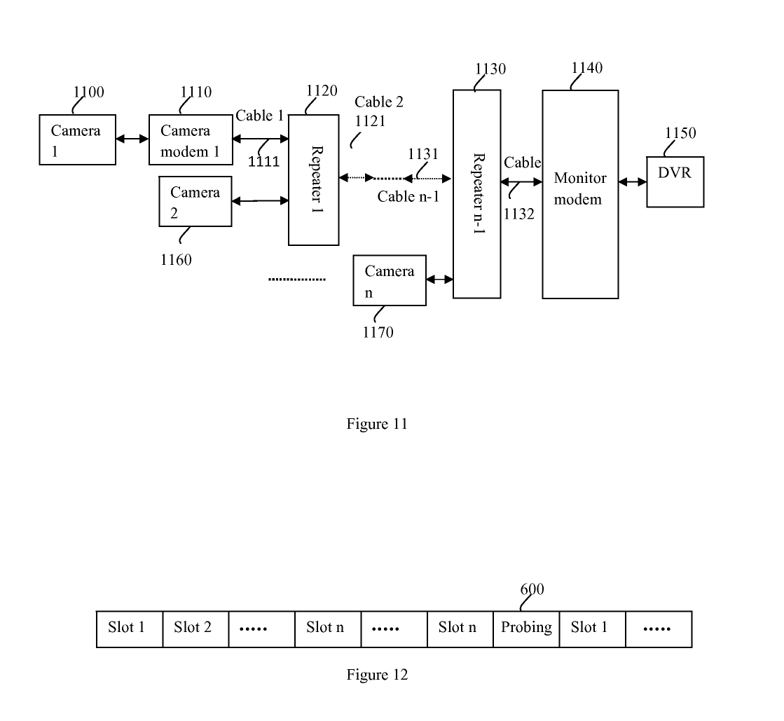

The present invention provides a mechanism to connect a camera modem and a monitor modem together to function as a repeater as shown in FIG. 9. In the downstream direction, the monitor modem 410 sends the downstream repeater output signal 411 directly to the input port of the downstream repeater input signal 220 at the camera modem 420; in the upstream direction the camera modem 420 sends the upstream repeater output signal 412 to the input port of the upstream repeater input signal 353 at the monitor modem 410. The signals connecting the two modems are both digital signals and repeaters can be used as many times as necessary to extend the cable. Since the analog video remains in the digital format intact, the analog video quality does not degrade over repeaters or extended cables. In addition to cable interfaces 415 and 416, the repeater can provide an optional camera interface as shown in FIG. 9, including analog video input 421, downstream digital IP video/service data 422, upstream IP data 423 and upstream service data 424. This allows a camera to be directly connected to the repeater. The repeater without optional camera interface is used to connect multiple cameras in a star topology, as detailed in FIG. 10 while the repeater with optional camera interface is used to connect multiple cameras in a daisy-chain topology, as detailed in FIG. 11.

An example of the repeater connection without using the camera interface to form a star topology is shown in FIG. 10, where the central node is repeater 1 labeled as 520 and leaf nodes are cameras 1, 2, . . . , n labeled as 500, 502, . . . , 504 respectively. In this exemplary security camera network, m repeaters 520, 530 are connected by cables 521. The number m can be any integer number greater than or equal to 0. If m is equal to zero, that is, no repeater is used, then FIG. 10 becomes the same as FIG. 1. if one or more repeaters are used, multiple cameras are connected by the repeater 520. The transmission distance can be extended by using repeaters and the cables 521, 531 between repeater 520 and monitor modem 540 are shared by multiple cameras including 500, 502, . . . , 504. The last repeater 530 is connected with the monitor modem 540, which is connected to the monitor device 550 such as a DVR.

FIG. 11 shows another example of using repeater connection to form a daisy-chain topology where multiple cameras are connected with the multiple repeaters through the optional camera interface. Each repeater is directly connected with a new camera through its optional camera interface. At repeater 1 labeled as 1120, the traffic between DVR 1150 and camera 1 labeled as 1100 is relayed. At the same time, camera 2 labeled as 1160 is directly connected to repeater 1 through its camera interface. Other cameras such as 1170 are connected to other repeaters such as 1130 in a similar fashion. Depending on the factors such as the location of cameras and DVR, a star topology, a daisy-chain topology or a hybrid combination of both can be chosen to minimize the total installation cost of a specific security camera network.

The present invention provides a method for one monitor modem with single transceiver inside to exchange data with multiple camera modems by a multiple access scheme. Each camera modem can communicate independently with the monitor modem. If there are n cameras, n communication links are established by using a single monitor modem. In one embodiment, the n communication links use time-division multiple access to share the same monitor modem. The communication time is divided into multiple time slots as shown in FIG. 12. Time slot i is assigned for communication link between camera modem i and the monitor modem. To avoid multiple camera modems sending at the same slot and causing collision, negotiation and synchronization are necessary.

In an established communication link, half duplex or full duplex can be used to communicate in both directions. For example, half duplex can be used in FIG. 12 in order to reduce the complexity of analog design. In slot i, the modem does not transmit and receives at the same time. Thus communications in both directions can share the same frequency bandwidth on the same cable. If frequency division multiple access (FDMA) based full duplex is used, signals in two directions occupy different frequency band. Filters are usually needed to separate signals in two directions to prevent interference from each other. OFDMA can also be used to support full duplex. Typically different frequency bins are assigned to downstream and upstream respectively. All of these schemes can be implemented within the scope of the present invention.

In FIG. 12, a probing slot 600 can be inserted between two groups of multiple time slots. In the probing slot, a training sequence can be sent to different cables with unknown status. By checking the response corresponding to the training sequence, it can be found out if a new camera is connected into the system or a camera just leaves the systems. If a new camera modem is found, slots can be assigned to the new camera modem and the communication link between the new camera modem and the monitor modem can be established. If a camera modem leaves the system, its assigned slots can be released and assigned to other connected camera modems. During this process, other communication links shall not be disrupted. In the probing slot, signals can also be sent to the connected cameras and the probing signals can be used as training to improve synchronization or equalization. The present invention does not limit how the slots are assigned. Some camera modems can occupy more slots than other cameras. Based on the required data rate, camera modems can negotiate with the monitor modems to request or release slots dynamically. For example, when two repeaters are connected back to back, all the slots can be occupied by a single modem pair.

What is claimed is:

1. A system for transmitting video signals, comprising:
multiple cameras each of that generates at least two video signals, one of the video signals being baseband analog videos and the other video signal being digital high definition video signals;
multiple camera modems each of that processes the two video signals, transmits the resulting downstream signals over the coaxial cable and receives incoming upstream signals from the coaxial cable;
a monitor modem that receives videos signals on multiple coaxial cables from the camera modems, processes the videos signals and regenerates the baseband analog video signals and digital high definition video signals;
a video receiving device that displays, store and/or playback videos.

2. The system of claim 1, wherein the camera modem comprises:
an analog video processor that converts analog video signal into digital data by digitalizing and compressing;
a multiplexer, that multiplexes at least the digital data resulting from the analog video and the digital high definition video into downstream digital signal;
a modulator that modulates the downstream digital signal in a format suitable for transmission over the coaxial cable;
a demodulator that receives upstream signal from the coaxial cable, decodes the upstream signal and generates upstream digital signal.
a de-multiplexer that de-multiplexes the upstream digital signal into several digital streams.

3. The system of claim 2,
wherein the analog video processor decodes or digitalizes analog video into raw digital video and compresses the raw digital video to reduce the transmission data rate,
wherein part of the downstream digital signal is in the format of IP packets,
wherein part of the downstream digital signal comprises audio signal,
wherein part of the upstream digital signal comprises service data including the signal controlling the position and orientation of camera and audio signal,
wherein the demodulator output is sent out as upstream repeater output for relaying the digital signal to extend the transmission length, and part of the downstream digital signal is received from a downstream repeater input for relaying the digital signal to extend the transmission length.

4. The system of claim 1, wherein the monitor modem comprises:
a demodulator that receives and demodulates signal from multiple coaxial cables and regenerates downstream digital signal;
a de-multiplexer that de-multiplexes the downstream digital signal into at least a stream of digital high definition videos and a stream of digital data for deriving the analog videos;
an analog video de-processor that converts digital data into multiple analog videos;
an IP engine that processes the IP packets;
a multiplexer that multiplexes IP packets and other digital data into one upstream digital signal;
a modulator that modulates and transmits the upstream digital signal over the coaxial cable.

5. The system of claim 4,
wherein part of the upstream digital signal is in the format of IP packets,
wherein part of the upstream digital signal comprises service data including the signal controlling the position and orientation of camera, and audio signal,
wherein demodulator output is sent out as downstream repeater output for relaying the digital signal to extend the transmission length, and part of the upstream digital signal is received from an upstream repeater input for relaying the digital signal to extend the transmission length,
wherein either the IP engine is configured to be a full-blown switch that forwards IP packets according destination address, or a partial switch that forwards all upstream packets to cameras regardless the address or forwards only broadcast and multicast packets,
wherein an video de-processor de-compresses the digital data into multiple raw digital videos and converts raw digital videos into multiple analog videos,
wherein the analog video is displayed directly on an analog videos display device,
wherein the raw digital video is sent to a digital video interface for storing and display.

6. The system of claim 1, further comprising zero, one or multiple repeaters wherein a monitor modem is connected to a camera modem.

7. The system of claim 6,
wherein the downstream repeater output of the monitor modem is connected to the downstream repeater input of the camera modem and the upstream repeater output of the camera modem is connected to the upstream repeater input of the monitor modem,
wherein signals are transmitted over the coaxial cable by the monitor modem and the camera modem.

8. The system of claim 1, wherein the monitor modem uses a single transmitter and a single receiver to exchange data with multiple camera modems by time or frequency multiplexing without signal collision from multiple camera modems.

9. A method for transmitting video signals, at the camera side, the method comprising:
converting analog video signal into digital data by digitalizing and compressing;
multiplexing at least the digital data resulting from the analog video and the digital high definition video into downstream digital signal;
modulating the downstream digital signal in a format suitable for transmission over the coaxial cable;
demodulating the received upstream signal from the coaxial cable and generating upstream digital signal.
de-multiplexing the upstream digital signal into several digital streams.

10. The method of claim 9, at the camera side,
wherein an analog video processor decodes or digitalizes analog video into raw digital video and compresses the raw digital video to reduce the transmission data rate,
wherein part of the downstream digital signal is in the format of IP packets,
wherein part of the downstream digital signal comprises audio signal,
wherein part of the upstream digital signal comprises service data including the signal controlling the position and orientation of camera and audio signal,
wherein the demodulated signal is sent out as upstream repeater output for relaying the digital signal to extend the transmission length, and part of the downstream digital signal is received from a downstream repeater input for relaying the digital signal to extend the transmission length.

11. The method of claim 9, at the monitor side, comprising:
demodulating signal from multiple coaxial cables and regenerating downstream digital signal;
de-multiplexing the downstream digital signal into at least a stream of digital high definition videos and a stream of digital data for deriving the analog videos;
converting digital data into multiple analog videos;
processing the IP packets;
multiplexing IP packets and other digital data into one upstream digital signal;
modulating and transmitting the upstream digital signal over the coaxial cable.

12. The method of claim 11, at the monitor side,
wherein part of the upstream digital signal is in the format of IP packets,
wherein part of the upstream digital signal comprises service data including the signal controlling the position and orientation of camera, and audio signal,
wherein the demodulated signal is sent out as downstream repeater output for relaying the digital signal to extend the transmission length, and part of the upstream digital signal is received from an upstream repeater input for relaying the digital signal to extend the transmission length,
wherein either IP packets are forwarded according destination address, or all the upstream packets are forwarded to cameras regardless the address, or only broadcast and multicast packets are forwarded,
wherein an video de-processor de-compresses the digital data into multiple raw digital videos and converts raw digital videos into multiple analog videos,
wherein the analog video is displayed directly on an analog videos display device,
wherein the raw digital video is sent to a digital video interface for storing and display.

13. The method of claim 9, further comprising zero, one or multiple repeaters wherein a monitor modem is connected to a camera modem.

14. The method of claim 13,
wherein the downstream repeater output of the monitor modem is connected to the downstream repeater input of the camera modem and the upstream repeater output of the camera modem is connected to the upstream repeater input of the monitor modem,
wherein signals are transmitted over the coaxial cable by the monitor modem and the camera modem.

15. The method of claim 9, wherein the monitor modem uses a single transmitter and a single receiver to exchange data with multiple camera modems by time or frequency multiplexing without signal collision from multiple camera modems.
